(19) United States
(12) Patent Application Publication
(10) Pub. No.: US 2013/0055217 A1
(43) Pub. Date: Feb. 28, 2013

(54) BREAKPOINT SYNCHRONIZATION FOR MODIFIED PROGRAM SOURCE CODE

(71) Applicants: Alan S. Boxall, Markham (CA); Steve Cooper, Markham (CA)

(72) Inventors: Alan S. Boxall, Markham (CA); Steve Cooper, Markham (CA)

(73) Assignee: INTERNATIONAL BUSINESS MACHINES CORPORATION, Armonk, NY (US)

(21) Appl. No.: 13/215,668

(22) Filed: Aug. 23, 2011

(51) Int. Cl. G06F 9/44

(52) U.S. Cl. 717/129

(57) ABSTRACT

A method for breakpoint synchronization in program source code includes in response to creation of a breakpoint in the program source code, storing by a computer, in a breakpoint store, a line number of the breakpoint and line contents corresponding to text located at the stored line number in the program source code; in the event the program source code is modified, synchronizing the breakpoint with the modified program source code, wherein synchronizing the breakpoint with the modified program source code comprises: searching the modified program source code for the stored line contents; identifying an updated line number for the breakpoint; inserting the breakpoint at the updated line number in the modified program source code; and updating the breakpoint store with the updated line number.

### BACKGROUND

This disclosure relates generally to the field of software development, and more particularly to breakpoints that are used for debugging program source code during software development.

A breakpoint is a stopping or pausing place that is inserted into program source code for debugging purposes. Breakpoints are used to stop a program at a desired location so that the state of a program can be observed at that location, to enhance understanding of the program's design and behavior, or to investigate a particular bug in the program's flow. During execution of the program by a debugger, when the debugger encounters a breakpoint, the debugger pauses at the point in the program source code at which the breakpoint is located. This pause allows the developer to inspect the test environment (for example, the contents of general purpose registers, memory, logs, files, variable values, and the like) at the breakpoint to find out whether the program is functioning as expected at that point.

Breakpoints may be added to program source code either before or during a debugging session, and may be associated with a particular line number in the file containing the program source code. However, if the program source code is modified, the line that was used set the breakpoint may be removed or repositioned in the source code file. This may render the breakpoint meaningless, as the debugger will pause at an incorrect point in the program during further debugging, due to the incorrect line number associated with the breakpoint. Therefore, breakpoints may be discarded when the program source code is modified, forcing the programmer to re-create the breakpoints whenever the program source code is modified, which may be time consuming. Also, while a customized editor may update the breakpoint line numbers as the user modifies the source, modifying the program source code in a different editor may not update the breakpoints, potentially causing breakpoints to become invalid. Therefore, a programmer may be forced to use the customized editor in order to maintain the breakpoint.

### BRIEF SUMMARY

In one aspect, a method for breakpoint synchronization in program source code includes in response to creation of a breakpoint in the program source code, storing by a computer, in a breakpoint store, a line number of the breakpoint and line contents corresponding to text located at the stored line number in the program source code; in the event the program source code is modified, synchronizing the breakpoint with the modified program source code, wherein synchronizing the breakpoint with the modified program source code comprises: searching the modified program source code for the stored line contents; identifying an updated line number for the breakpoint; inserting the breakpoint at the updated line number in the modified program source code; and updating the breakpoint store with the updated line number.

In another aspect, a computer program product comprising a computer readable storage medium containing computer code that, when executed by a computer, implements a method for breakpoint synchronization in program source code, wherein the method includes in response to creation of a breakpoint in the program source code, storing, in a breakpoint store, a line number of the breakpoint and line contents corresponding to text located at the stored line number in the program source code; in the event the program source code is modified, synchronizing the breakpoint with the modified program source code, wherein synchronizing the breakpoint with the modified program source code comprises: searching the modified program source code for the stored line contents; identifying an updated line number for the breakpoint; inserting the breakpoint at the updated line number in the modified program source code; and updating the breakpoint store with the updated line number.

In another aspect, a system for breakpoint synchronization in program source code includes a synchronization module comprising a computer configured to: in response to creation of a breakpoint in the program source code, store, in a breakpoint store, a line number of the breakpoint and line contents corresponding to text located at the stored line number in the program source code; in the event the program source code is modified, synchronize the breakpoint with the modified program source code, wherein synchronizing the breakpoint with the modified program source code comprises: searching the modified program source code for the stored line contents; identifying an updated line number for the breakpoint; inserting the breakpoint at the updated line number in the modified program source code; and updating the breakpoint store with the updated line number.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 illustrates a flowchart of an embodiment of a method for breakpoint creation, storage, and synchronization.

FIG. 2 illustrates a flowchart of an embodiment of a method for synchronization of a breakpoint with modified program source code.

FIG. 3 illustrates an embodiment of a code segment including a breakpoint.

FIG. 4 illustrates an embodiment of the code segment of FIG. 3 after modification of the code segment.

FIG. 5 illustrates an embodiment of the code segment of FIG. 4 after synchronization of the breakpoint with the modified code segment.

FIG. 6 illustrates an embodiment of a system for breakpoint synchronization for modified program source code.

FIG. 7 illustrates a block diagram of a computer that may be used in conjunction with methods for breakpoint synchronization for modified program source code.

### DETAILED DESCRIPTION

Embodiments of systems and methods for breakpoint synchronization for modified program source code are provided, with exemplary embodiments being discussed below in detail. To avoid invalidation of breakpoints in program source code when the program source code is modified, the breakpoint and associated line number may be stored separately from the program source code in a central repository referred to as a breakpoint store, with additional information including the contents (i.e., the text) of a line or lines with which the breakpoint is associated. The breakpoints may then be synchronized with the modified program source code when it is opened in a debugger by searching for the stored line contents in the modified program source code. Programmers are therefore not tied to a specific debugger or editor in order to manage the breakpoints, as the line contents stored in the breakpoint store may synchronize with program source code in any debugger or editor that supports externally stored breakpoints. This is particularly beneficial for team-based software development where many different programmers may edit a program source code file.

Some types of program source code may be changed each time the program is built, such as program source code processed by SQL, macro pre-processors or debugging from a compiler listing. Breakpoints may be invalidated each time the program is built in such types of program source code. However, separate storage of breakpoint line contents information allows synchronization of the breakpoints with the program source code each time it is changed. Breakpoint synchronization may also be used for program listings, disassembly, and any other view of a program.

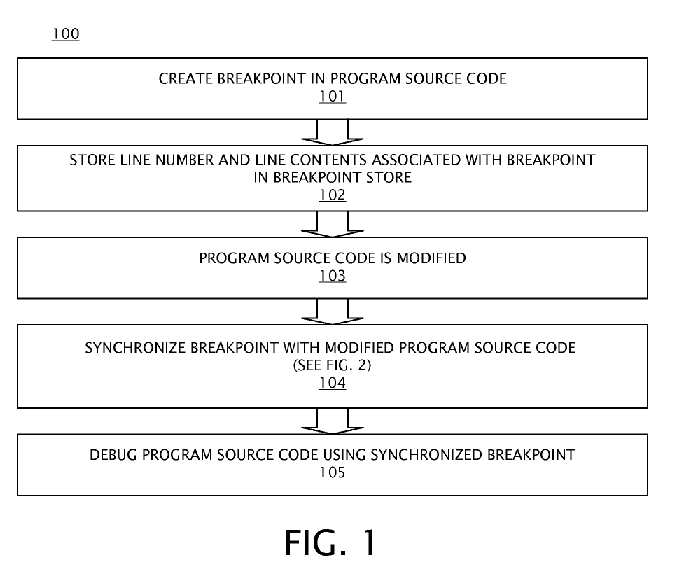

FIG. 1 illustrates a flowchart of an embodiment of a method 100 for breakpoint creation, storage, and synchronization. Method 100 may be used in conjunction with program source code written in any computer language, including but not limited to, Java™, Visual Basic, C, Python, or C++. In block 101, a breakpoint is created at a particular line number in program source code. In block 102, the breakpoint information is stored in a breakpoint store. The breakpoint information includes the line number and the contents of the line number. For more complex synchronization, one or more lines of text located on lines preceding and/or following the breakpoint may also be stored with the breakpoint information in the breakpoint store. The breakpoint information may additionally include the file name that holds the program source code in some embodiments, or, in other embodiments, the breakpoint store may be specific to the file that holds the program source code. A plurality of breakpoints associated with a particular program source code file may be created and stored in the breakpoint store using the steps described in blocks 101 and 102 of method 100. In block 103, the program source code that is associated with one or more stored breakpoints is modified. The program source code may be modified using any appropriate program source editor that may be used to create and/or modify program source code, including but not limited to Eclipse. Lines may be added to and/or deleted from the program source code during modification, and the text within one or more lines may be changed.

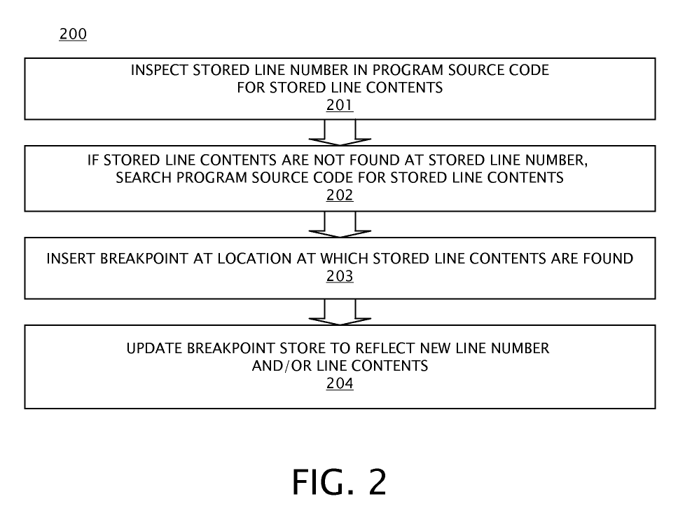

Then, flow proceeds to block 104, in which the breakpoints in the program source code are synchronized with the modified program source code. Synchronization may be triggered by, for example, opening the program source code in a debugger. Synchronization is discussed in further detail with respect to FIG. 2, which shows a flowchart of an embodiment of a method 200 for synchronization of a breakpoint with modified program source code. If multiple breakpoints are associated with the modified program source code, method 200 may be repeated for each associated breakpoint in block 104. Additional details regarding synchronization will be discussed in hereinafter, with respect to FIG. 2. After all of the breakpoints associated with the program source code are synchronized in block 104, the method 100 proceeds to block 105, in which the program source code is debugged using the breakpoint(s) that were synchronized with the modified program source code.

Turning to method 200 of FIG. 2, a flowchart of an embodiment of a method 200 for synchronization of a breakpoint with modified program source code is shown. In block 201, the program source code is inspected at the stored line number associated with a breakpoint to determine if the stored line contents are located at the stored line number. If the text at the stored line number in the program source code matches the stored line contents in the breakpoint store, the breakpoint is installed at the stored line number. However, if the stored line contents are not found at the stored line number in block 201, then flow proceeds to block 202, and the stored line contents are searched for in the program source code. This may be performed by checking a predetermined range of lines before and after the stored line number. The predetermined number of lines may be specified by the programmer in some embodiments. If the stored line contents are not found in the predetermined range of lines, the breakpoint is not installed and the programmer may be alerted. Additional lines before and after the stored line number may be inspected until the stored line contents, or text that are similar to the stored line contents, are found in the program source code. The programmer may be given the option of discarding the breakpoint if the line contents are not located within a predetermined range of lines, searching additional lines in the program source code, installing the breakpoint on the original line number even if it the text does not match the stored line contents, or searching for lines in the modified program source code that are similar to the stored line contents. In cases where the text of the stored line number in the program source code was modified, lines with contents that are similar to the stored line contents may be identified using any appropriate text searching technique including but not limited to regular expression matching. If additional lines of text are stored with the breakpoint (i.e., the current line and one or more preceding or following lines), it may be possible to identify the breakpoint location in the modified program source code in the presence of complicated modifications to the program source code. Once the stored line contents, or contents deemed to be sufficiently similar to the stored line contents, are identified in the program source code, the breakpoint is inserted in the program source code at the identified location in block 203. The breakpoint store is then updated as needed with the new line number and new line contents in block 204.

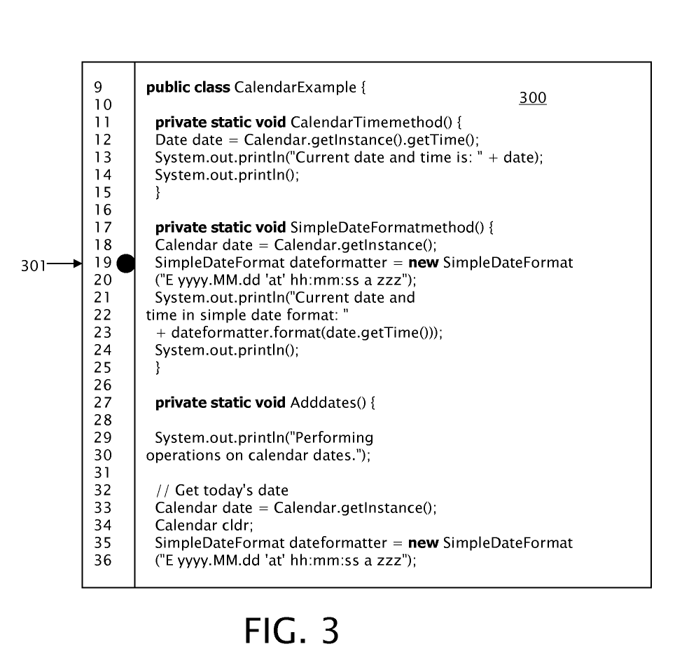

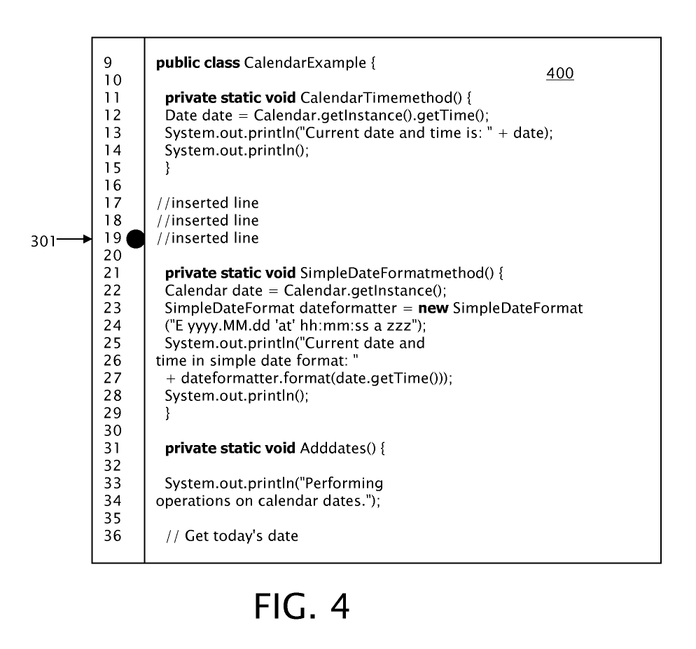

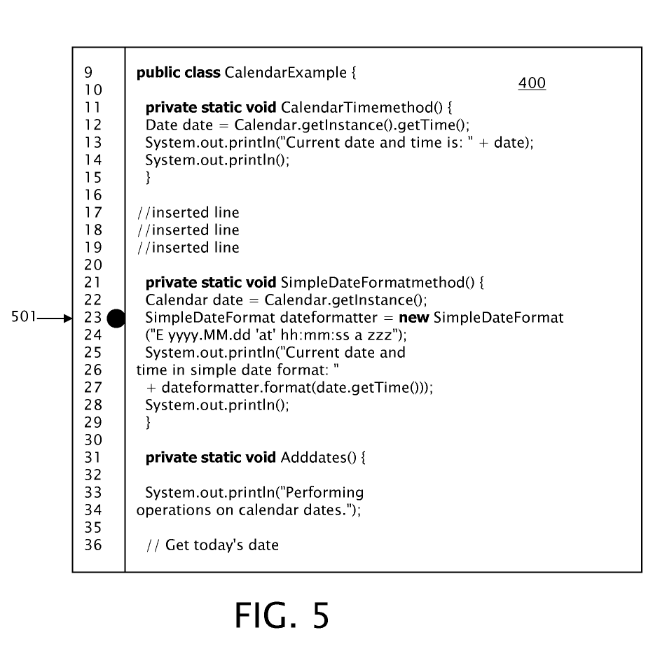

An example of execution of FIGS. 1 and 2 is discussed below with respect to FIGS. 3-5, which show an example code segment with a breakpoint. FIG. 3 shows a code segment 300, with a breakpoint 301 that is created at line 19 (block 101 of FIG. 1). When the breakpoint is created, the line number and contents of the line are stored in the breakpoint store (block 102 of FIG. 1). Therefore, for the breakpoint 301 of FIG. 3, the breakpoint line (19) and the line contents (SimpleDateFormat dateformatter=new SimpleDateFormat) are stored in the breakpoint store. The contents of lines that precede and/or follow line 19, for example, the contents of line 20 [“(“E yyyy.MM.dd ‘at’ hh:mm:ss a zzz”);”] may also be stored in the breakpoint store with the information for breakpoint 301. In some embodiments, the breakpoint store may hold breakpoints from multiple program source code files, and the file name that contains code segment 300 may also be stored in the breakpoint store with the breakpoint. In other embodiments, the breakpoint store that holds breakpoint 301 may be specific to the file that contains code segment 300. The code segment 300 is then modified by a programmer (FIG. 1 block 103), resulting in the modified code segment 400 shown in FIG. 4. In the modified code segment 400 of FIG. 4, a plurality of lines have been inserted into the modified code segment 400. Therefore, the location of breakpoint 301, which is still located at line 19, is incorrect. Breakpoint synchronization may then be triggered by, for example, opening the modified code segment 400 in a debugger. Flow then proceeds to block 104 of FIG. 1, in which the breakpoint is synchronized using the method 200 of FIG. 2. First, in block 201, line 19 of the modified code segment 400 is inspected to determine if the contents of line 19 match the stored line contents in the breakpoint store. Because the contents of line 19 do not match the stored line contents in the breakpoint store, flow then proceeds to block 202, and the stored line contents are searched in the modified code segment 400. In the example of FIG. 4, the stored line contents are found at line 23. When the stored line contents are found, flow proceeds to block 203, and the synchronized breakpoint 501 is inserted in the modified code segment 400 at line 23, as shown in FIG. 5. Then, the breakpoint store is updated with the synchronized breakpoint line. The program source code may then be debugged using synchronized breakpoint 501 in block 104 of FIG. 1.

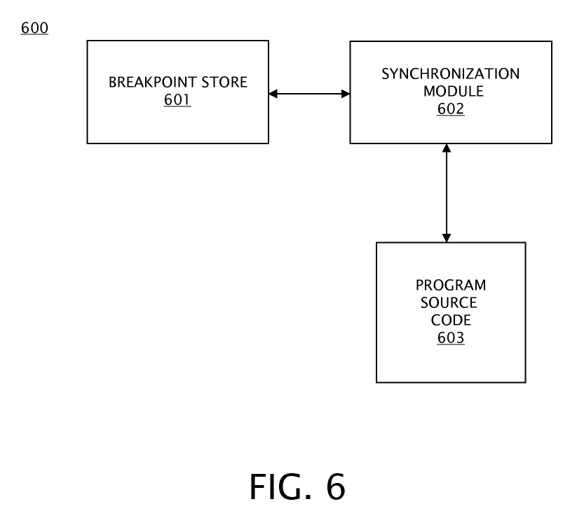

FIG. 6 illustrates an embodiment of a system 600 for breakpoint storage and synchronization including a synchronization module 602 that implements methods 100 and 200 of FIGS. 1 and 2. Breakpoint store 601 holds breakpoint information, including line numbers and line contents. The contents of additional lines preceding and/or following the stored line number may also be stored in breakpoint store 601 in some embodiments. Breakpoint store 601 may hold breakpoints for a single program source code file (such as program source code file 603), or for multiple program source code files (not shown). In the latter case, the file name of the associated program source code is also stored with each breakpoint. The synchronization module 602 writes breakpoint information to breakpoint store 601 when a breakpoint is created in program source code file 603. Synchronization module 602 also searches program source code file 603 using stored line contents from breakpoint store 601, as outlined above with respect to method 200 of FIG. 2, to determine the correct location of breakpoints from breakpoint store 601 in a program source code file 603 in the event that program source code file 603 is modified. When a new line number and/or line contents for a breakpoint is determined, the synchronization module re-inserts the breakpoint at the correct location in program source code file 603, and updates the breakpoint store 601 with the new line number and/or line contents.

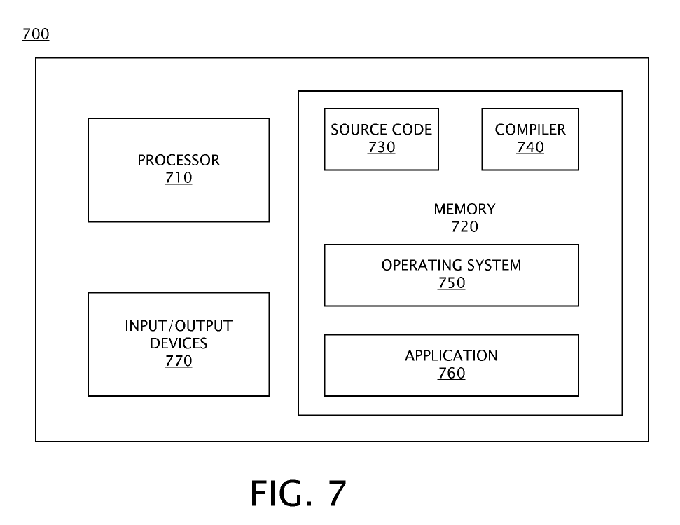

FIG. 7 illustrates an example of a computer 700 which may be utilized by exemplary embodiments of a method for breakpoint synchronization for modified program source code as embodied in software. Various operations discussed above may utilize the capabilities of the computer 700. One or more of the capabilities of the computer 700 may be incorporated in any element, module, application, and/or component discussed herein.

The computer 700 includes, but is not limited to, PCs, workstations, laptops, PDAs, palm devices, servers, storages, and the like. Generally, in terms of hardware architecture, the computer 700 may include one or more processors 710, memory 720, and one or more input and/or output (I/O) devices 770 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 710 is a hardware device for executing software that can be stored in the memory 720. The processor 710 can be virtually any custom made or commercially available processor, a central processing unit (CPU), a digital signal processor (DSP), or an auxiliary processor among several processors associated with the computer 700, and the processor 710 may be a semiconductor based microprocessor (in the form of a microchip) or a macroprocessor.

The memory 720 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 720 may incorporate electronic, magnetic, optical, and/or other types of storage media. Note that the memory 720 can have a distributed architecture, where various components are situated remote from one another, but can be accessed by the processor 710.

The software in the memory 720 may include one or more separate programs, each of which comprises an ordered listing of executable instructions for implementing logical functions. The software in the memory 720 includes a suitable operating system (O/S) 750, compiler 740, source code 730, and one or more applications 760 in accordance with exemplary embodiments. As illustrated, the application 760 comprises numerous functional components for implementing the features and operations of the exemplary embodiments. The application 760 of the computer 700 may represent various applications, computational units, logic, functional units, processes, operations, virtual entities, and/or modules in accordance with exemplary embodiments, but the application 760 is not meant to be a limitation.

The operating system 750 controls the execution of other computer programs, and provides scheduling, input-output control, file and data management, memory management, and communication control and related services. It is contemplated by the inventors that the application 760 for implementing exemplary embodiments may be applicable on all commercially available operating systems.

Application 760 may be a source program, executable program (object code), script, or any other entity comprising a set of instructions to be performed. When a source program, then the program is usually translated via a compiler (such as the compiler 740), assembler, interpreter, or the like, which may or may not be included within the memory 720, so as to operate properly in connection with the O/S 750. Furthermore, the application 760 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 770 may include input devices such as, for example but not limited to, a mouse, keyboard, scanner, microphone, camera, etc. Furthermore, the I/O devices 770 may also include output devices, for example but not limited to a printer, display, etc. Finally, the I/O devices 770 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 770 also include components for communicating over various networks, such as the Internet or intranet.

If the computer 700 is a PC, workstation, intelligent device or the like, the software in the memory 720 may further include a basic input output system (BIOS) (omitted for simplicity). The BIOS is a set of essential software routines that initialize and test hardware at startup, start the O/S 750, and support the transfer of data among the hardware devices. The BIOS is stored in some type of read-only-memory, such as ROM, PROM, EPROM, EEPROM or the like, so that the BIOS can be executed when the computer 700 is activated.

When the computer 700 is in operation, the processor 710 is configured to execute software stored within the memory 720, to communicate data to and from the memory 720, and to generally control operations of the computer 700 pursuant to the software. The application 760 and the O/S 750 are read, in whole or in part, by the processor 710, perhaps buffered within the processor 710, and then executed.

When the application 760 is implemented in software it should be noted that the application 760 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 760 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 760 is implemented in hardware, the application 760 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The technical effects and benefits of exemplary embodiments include preserving of breakpoints in program source code after modification and across different editors.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for breakpoint synchronization in program source code, the method comprising:
in response to creation of a breakpoint in the program source code, storing by a computer, in a breakpoint store, a line number of the breakpoint and line contents corresponding to text located at the stored line number in the program source code;
in the event the program source code is modified, synchronizing the breakpoint with the modified program source code, wherein synchronizing the breakpoint with the modified program source code comprises:
searching the modified program source code for the stored line contents;
identifying an updated line number for the breakpoint;
inserting the breakpoint at the updated line number in the modified program source code; and
updating the breakpoint store with the updated line number.

2. The method of claim 1, wherein the line contents further comprise text located in one or more additional lines located adjacent to the stored line number in the program source code.

3. The method of claim 1, wherein searching the modified program source code for the stored line contents comprises searching a predetermined range of lines before and after the stored line number for the stored line contents.

4. The method of claim 1, wherein searching the modified program source code for the stored line contents comprises searching for text in the program source code that is similar to the stored line contents.

5. The method of claim 1, wherein synchronizing the breakpoint with the modified program source code is triggered by opening the modified program source code in a debugger.

6. The method of claim 1, wherein the breakpoint store comprises a plurality of breakpoints with associated stored line numbers and line contents.

7. The method of claim 6, wherein file names associated with the breakpoints are stored with the associated stored line numbers and line contents for each of the plurality of breakpoints.

8. The method of claim 6, further comprising synchronizing a plurality of breakpoints in the breakpoint store with the modified program source code.

9. A computer program product comprising a computer readable storage medium containing computer code that, when executed by a computer, implements a method for breakpoint synchronization in program source code, wherein the method comprises:
in response to creation of a breakpoint in the program source code, storing, in a breakpoint store, a line number of the breakpoint and line contents corresponding to text located at the stored line number in the program source code;
in the event the program source code is modified, synchronizing the breakpoint with the modified program source code, wherein synchronizing the breakpoint with the modified program source code comprises:
searching the modified program source code for the stored line contents;
identifying an updated line number for the breakpoint;
inserting the breakpoint at the updated line number in the modified program source code; and
updating the breakpoint store with the updated line number.

10. The computer program product according to claim 9, wherein the line contents further comprise text located in one or more additional lines located adjacent to the stored line number in the program source code.

11. The computer program product according to claim 9, wherein searching the modified program source code for the stored line contents comprises searching a predetermined number of lines before and after the stored line number for the stored line contents.

12. The computer program product according to claim 9, wherein searching the modified program source code for the stored line contents comprises searching for text in the program source code that is similar to the stored line contents.

13. The computer program product according to claim 9, wherein synchronizing the breakpoint with the modified program source code is triggered by opening the modified program source code in a debugger.

14. The computer program product according to claim 9, wherein the breakpoint store comprises a plurality of breakpoints with associated stored line numbers and line contents.

15. The computer program product according to claim 14, wherein file names associated with the breakpoints are stored with the associated stored line numbers and line contents for each of the plurality of breakpoints.

16. The computer program product according to claim 14, further comprising synchronizing a plurality of breakpoints in the breakpoint store with the modified program source code.

17. A system for breakpoint synchronization in program source code comprises:
a synchronization module comprising a computer configured to:
in response to creation of a breakpoint in the program source code, store, in a breakpoint store, a line number of the breakpoint and line contents corresponding to text located at the stored line number in the program source code;
in the event the program source code is modified, synchronize the breakpoint with the modified program source code, wherein synchronizing the breakpoint with the modified program source code comprises:
searching the modified program source code for the stored line contents;
identifying an updated line number for the breakpoint;
inserting the breakpoint at the updated line number in the modified program source code; and
updating the breakpoint store with the updated line number.

18. The system of claim 17, wherein the line contents further comprise text located in one or more additional lines located adjacent to the stored line number in the program source code.

19. The system of claim 17, wherein searching the modified program source code for the stored line contents comprises searching a predetermined number of lines before and after the stored line number for the stored line contents.

20. The system of claim 17, wherein searching the modified program source code for the stored line contents comprises searching for text in the program source code that is similar to the stored line contents.
